(19) United States
(12) Patent Application Publication
(10) Pub. No.: US 2013/0319301 A1
(43) Pub. Date: Dec. 5, 2013

(54) Spray Nozzle, and Combustion Device Having Spray Nozzle

(71) Applicants: Hirofumi Okazaki, Mito (JP); Koji Kuramashi, Kure (JP); Hideo Okimoto, Kure (JP); Akihito Orii, Hitachi (JP); Kenichi Ochi, Kure (JP)

(72) Inventors: Hirofumi Okazaki, Mito (JP); Koji Kuramashi, Kure (JP); Hideo Okimoto, Kure (JP); Akihito Orii, Hitachi (JP); Kenichi Ochi, Kure (JP)

(73) Assignee: Babcock-Hitachi K.K., Chiyoda-ku, Tokyo (JP)

(21) Appl. No.: 13/979,340

(22) PCT Filed: Jan. 12, 2012
(86) PCT No.: PCT/JP2012/050411

§ 371 Date: Aug. 15, 2013

(30) Foreign Application Priority Data
Jan. 12, 2011 (JP) 2011-003614

(51) Int. Cl. F23D 11/38; F23D 1/00; F23K 5/20; B05B 17/00

(52) U.S. Cl. CPC F23D 11/38; B05B 17/00; F23D 1/005; F23K 5/20
USPC 110/261; 239/433; 431/215

(57) ABSTRACT

A spray nozzle is provided with upper and lower channels and from respective surfaces, the two channels form a cross shape, and become a fuel spray hole by communication of an intersecting part. A guide member is provided, in contact with the upstream-side channel, in a position overlapped with the intersecting part with respect to the spray direction of the spray nozzle. Spray fluid is branched with the guide member from the fuel fluid duct connected to the spray nozzle, passes through the upstream-side channel, to the intersecting part, and is sprayed. The spray fluid forms opposed flows toward the intersecting part in the upstream-side channel to collide with each other at an obtuse angle of 90° or greater, then is sprayed from the intersecting part, to form a thin fan-shaped liquid film. The liquid film is divided by a shearing force from the peripheral gas, atomized into spray particles.

### TECHNICAL FIELD

The present invention relates to a spray nozzle to atomize liquid fuel, and a combustion device having the spray nozzle.

### BACKGROUND ART

In a high-output and high-load combustion device such as a boiler for power generation, suspension firing for horizontal fuel combustion is adopted frequently. When liquid fuel such as fuel oil is used as fuel, the fuel is atomized with a spray nozzle, then floated in a furnace of the combustion device and is combusted. Further, when solid fuel, typified by coal is used as fuel, the solid fuel (coal) is ground into fine powdered coal having a particle diameter equal to or smaller than 0.1 mm. The fine powdered coal is conveyed with carrier gas such as air and is combusted in the furnace. Even in the case of the combustion device to combust the fine powdered coal, it is frequently accompanied by a combustion device using liquid fuel for activation or flame stabilization.

In the combustion of liquid fuel, when a spray particle diameter is large, combustion reaction is delayed, then the combustion efficiency is lowered, and ash dust and carbon monoxide may occur. Accordingly, upon liquid combustion, a method (pressure spraying) of pressurizing the fuel (spray fluid), generally to 0.5 to 5 MPa, and spraying it from a spray nozzle, to obtain fine particles having a particle diameter equal to or smaller than 300 μm, or a method (2 fluid spraying) of supplying air or vapor as spray medium for atomization to attain atomization is employed. In the pressure spraying, since the spray medium is not required and the device is downsized, it is frequently used in a small capacity combustion device such as the above-described combustion device for activation.

As the pressure spraying type spray nozzle, applying a vortex turning flow to the fuel so as to forma thinner liquid film from a spray hole by a centrifugal force (turning spray nozzle) is known. The liquid film is divided and atomized with a shearing force from peripheral gas. This method provides spray having liquid droplets with high kinetic momentum and high spray penetration.

With regard to the above-described method, a cross-slit spray nozzle, in which a nozzle main body is provided with crossed slit holes formed from both sides, to forma cross-shaped fluid duct and the intersecting part is used as a fuel spray hole, is known. Patent Document 1 to Patent Document 3 describe them. In this method, two flows toward the central intersecting part are formed in the upstream-side channel, and opposed flows are collided to form a thin fan-shaped liquid film from the intersecting part (spray hole). The liquid film is divided and atomized by shearing force from the peripheral gas. In this method, in comparison with the above-described turning spray nozzle, the kinetic momentum of liquid droplets is low and it is easy to keep the fine particles in the vicinity of the spray nozzle. Note that the present type nozzle is also described as a fan spray type spray nozzle from its fan-spray shape. Further, Patent Document 4 also shows a spray nozzle structure. The flow of fluid from a flow plate toward an orifice is issued from a gap therebetween, but the structure has no particular collision route.

### CITATION LIST

### Patent Document

[Patent Document 1] Japanese Unexamined Patent Application Publication No. Hei 4-303172

[Patent Document 2] Japanese Unexamined Patent Application Publication No. Hei 6-299932

[Patent Document 3] Japanese Unexamined Patent Application Publication No. 2000-345944

[Patent Document 4] Japanese Patent No. 2657101

### SUMMARY OF INVENTION

### Technical Problem

The above-described patent documents related to the cross slit spray nozzle, having an object of application mainly to a fuel injection device of an internal combustion engine, provide a valve for intermittent spray on the upstream side of the spray nozzle main body, provide space (fluid duct extending part) on its downstream side, and further, arrange a cross-shaped channel (spray nozzle main body) in its downstream.

As the fluid duct extending part is provided in the upstream of the spray nozzle main body, the flow velocity of the spray fluid entering from the valve is reduced, and the fuel flow is distributed in the upper channel. The spray fluid flowing in the upper channel becomes opposed flows toward the intersecting part of the cross-shaped channel, to form a thin fan-shaped liquid film by collision. At this time, it is desirable that the opposed flows collide at a more obtuse angle for atomization.

However, in the above-described patent documents, a part of the spray fluid passes from the valve through the fluid duct extending part and a flow linearly toward the intersecting part occurs. This flow has low contribution to collision. Accordingly, it increases the thickness of the liquid film, and causes difficulty in atomization. Further, the kinetic momentum of the issued liquid droplets is increased. In the Patent Document 3, the kinetic momentum is reduced by arrangement of the fluid duct extending part and the shape of the intersecting part. In this case, the fluid linearly flows from the fluid duct extending part to the intersecting part. Accordingly, it increases the thickness of the liquid film and causes difficulty in atomization. Further, the kinetic momentum of the issued liquid droplets is high.

The first object of the present invention is to cause fluid, which is branched and opposed in the upper channel of the cross-shaped channel, to collide with each other at an obtuse angle, to promote atomization, further, to propose a spray nozzle to reduce the kinetic momentum in the axial direction of issued liquid droplets.

Further, the Patent Documents 1 to 3 show the method of forming plural cross-shaped channels to increase the number of intersecting parts. By increasing the number of spray holes having a small cross sectional area, it is possible to increase the spray amount with small diameter of spray particles. However, since the plural cross-shaped channels are formed in the same plane, sprays formed from the respective spray holes easily collide with each other and connected with each other, thus the particle diameter is increased. The second object of the present invention is to propose a spray nozzle to prevent interference between the sprays formed from the respective spray holes.

Further, in the fuel injection device of an internal combustion engine, the injection amount is comparatively small whereas the injection pressure is comparatively high, i.e., 5 to 12 MPa. Further, as intermittent spraying is performed, turbulence occurs in the fluid flowing in the fluid duct, to prevent sedimentation of solid materials in the fluid duct. However, in a combustion device such as a boiler, as the injection amount is large, reduction of injection pressure is required from the viewpoint of reduction of energy consumption. In this case, the sedimentation of solid materials in the fluid duct may cause occlusion or deterioration of atomization. Further, as fluid often flows by a constant flow amount, turbulence does not easily occur in the flow, and easily causes sedimentation of solid materials in a part of the flow at a low flow velocity or small turbulence. When the solid materials grow by chemical reaction or the like, the occlusion of the fluid duct may occur, to cause the deterioration of atomization performance of the spray nozzle and the occurrence of large diameter particle. The third object of the present invention is to propose a spray nozzle to prevent sedimentation of solid materials in the fluid duct in the combustion device such as a boiler in which fluid often flows by a constant fluid amount.

### Solution to Problem

The present invention is a spray nozzle which pressurizes liquid fuel as spray fluid and supplies it from upstream to downstream of a fluid duct to spray it from an end, in which at least one channel is formed in respective both surfaces of a nozzle plate provided at the end of the spray nozzle, and an intersecting part of the two channels is used as a fuel spray hole. A guide member is in contact with the upstream-side channel provided in the both surfaces of the nozzle plate, the guide member is provided for spray fluid flowing through a fluid duct on the upstream side of the intersecting part, and the fluid is guided toward the fuel spray hole and collided from opposite directions.

Further, in the spray nozzle, the angle of the flow direction of the fluids guided toward the fuel spray hole and collided from the opposite directions with the guide member is an obtuse angle.

Further, in the spray nozzle, the nozzle plate has flat surfaces at different angles with respect to the spray nozzle axial direction, and plural fuel spray holes are formed by providing a plurality of at least one of the channels formed in the both surfaces of the nozzle plate and using combinations of the channels.

Further, in the spray nozzle, the axial direction of the plural fuel spray holes is inclined in a direction symmetric with respect to the flow direction of the spray fluid flowing through the fluid duct at the end of which the spray nozzle is provided, and issue is performed.

Further, in the spray nozzle, the fluid-duct cross-sectional area of the upstream-side channel of the channels is changed in the flow direction of the spray fluid flowing through the upstream-side channel.

Further, in the spray nozzle, the fluid-duct cross-sectional area of the upstream-side channel is decreased toward the fuel spray hole.

Further, in the spray nozzle, the upstream-side channels are mutually connected.

Further, in a combustion device, using liquid fuel as at least a part of fuel, and having a spray nozzle which pressurizes the liquid fuel and sprays it, comprising: a combustion furnace to combust fossil fuel; a fuel supply system to supply fuel and carrier gas to carry the fuel to the combustion furnace; a combustion gas supply system to supply combustion gas to the combustion furnace; a burner provided on a furnace wall of the combustion furnace and connected to the fuel supply system and the combustion gas supply system, to combust the fossil fuel; and a heat exchanger for heat exchange from combustion exhaust gas caused in the combustion furnace to the outside, the above-described spray nozzle is used as the spray nozzle.

### Advantageous Effects of Invention

The present invention is a spray nozzle to pressurize liquid fuel as spray fluid and supplies it from the upstream to the downstream of a fluid duct, and sprays it from its end. At least one channel is formed in both surfaces of a nozzle plate provided at the end of the spray nozzle, and an intersecting part of the two channels is used as a fuel spray hole. In the channels provided in the both surfaces of the nozzle plate, a guide member is provided for the spray fluid flowing through the upstream-side fluid duct of the intersecting part in contact with the upstream-side channel. It is possible to atomize the spray particle diameter by guiding the fluid from opposite directions toward the fuel spray hole to collide with each other. Accordingly, the combustion reaction is quickened, the combustion efficiency is improved, and the occurrence of ash dust and carbon monoxide is suppressed. Further, as the flow velocity of the spray particle is low and the spray particles easily stay in the vicinity of the spray nozzle, practically excellent advantages i.e. quickened ignition and improved flame stability are attained.

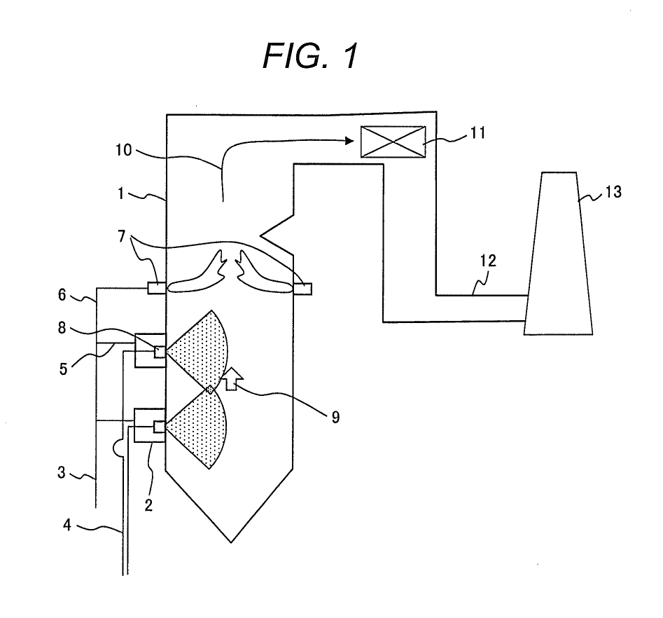

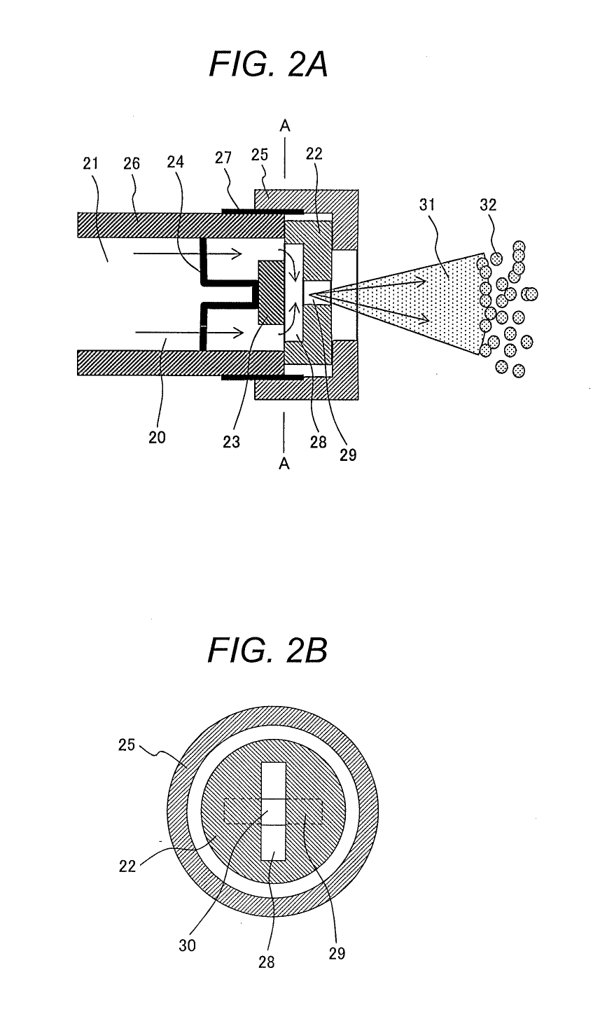

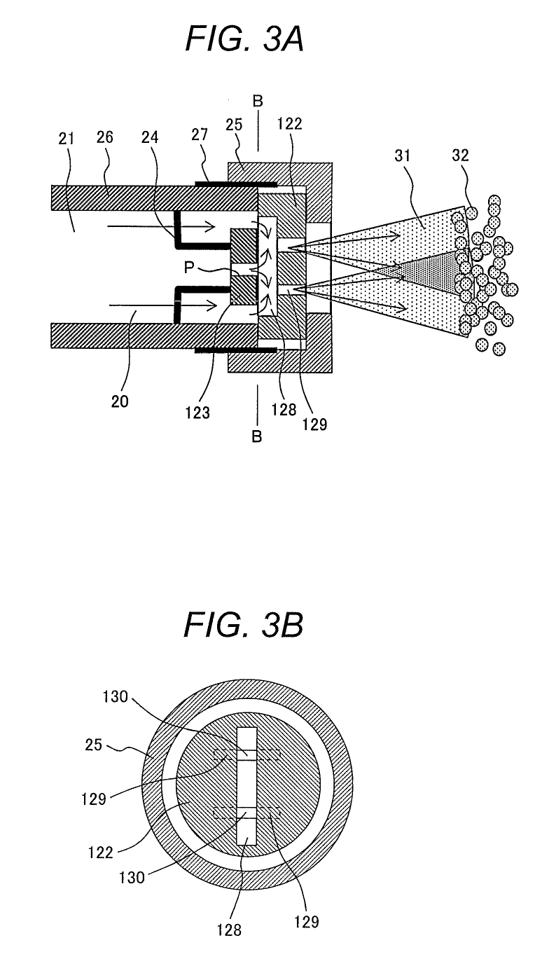

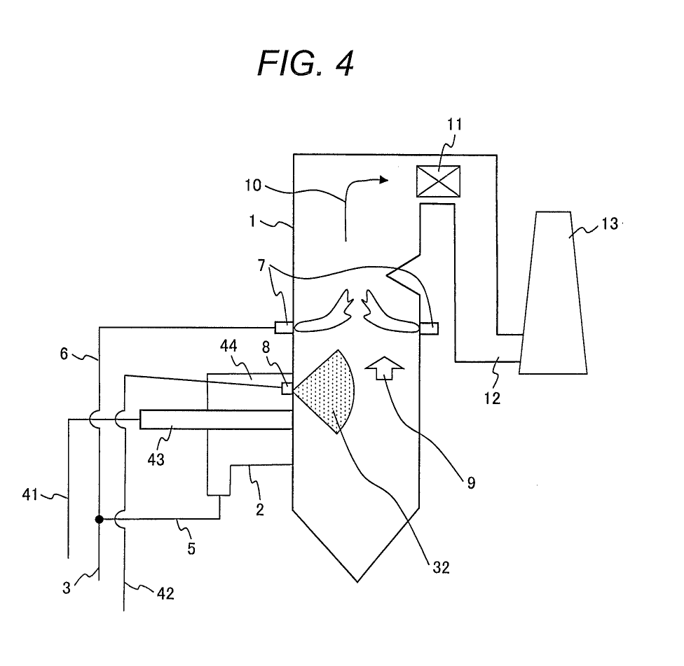

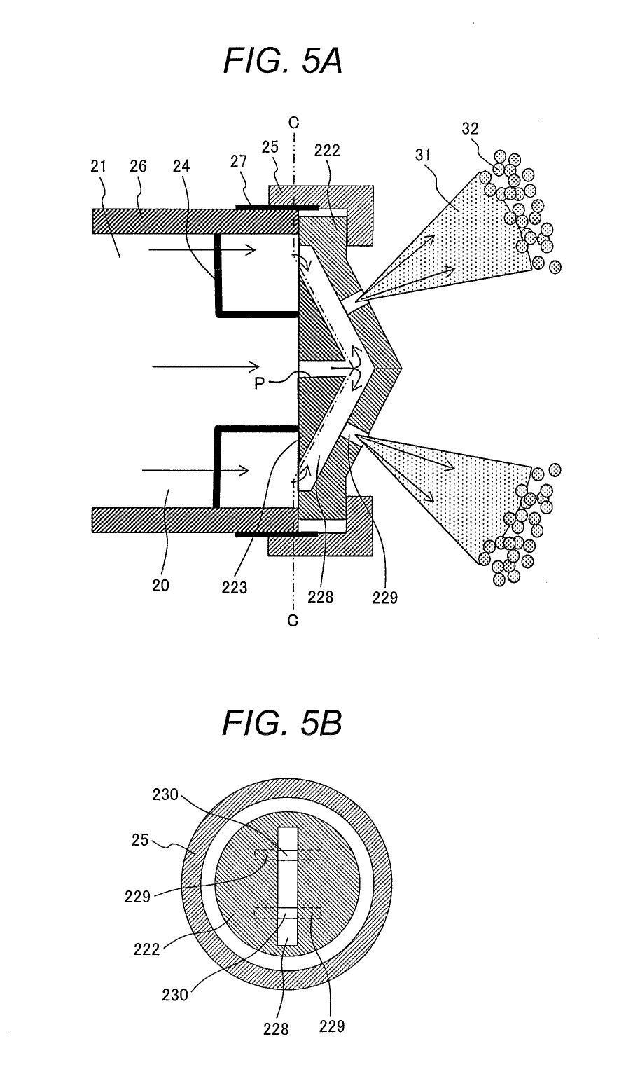

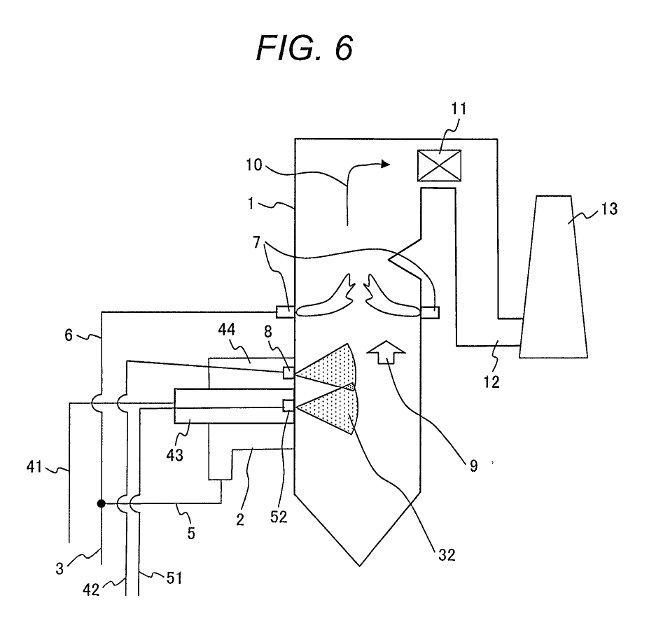

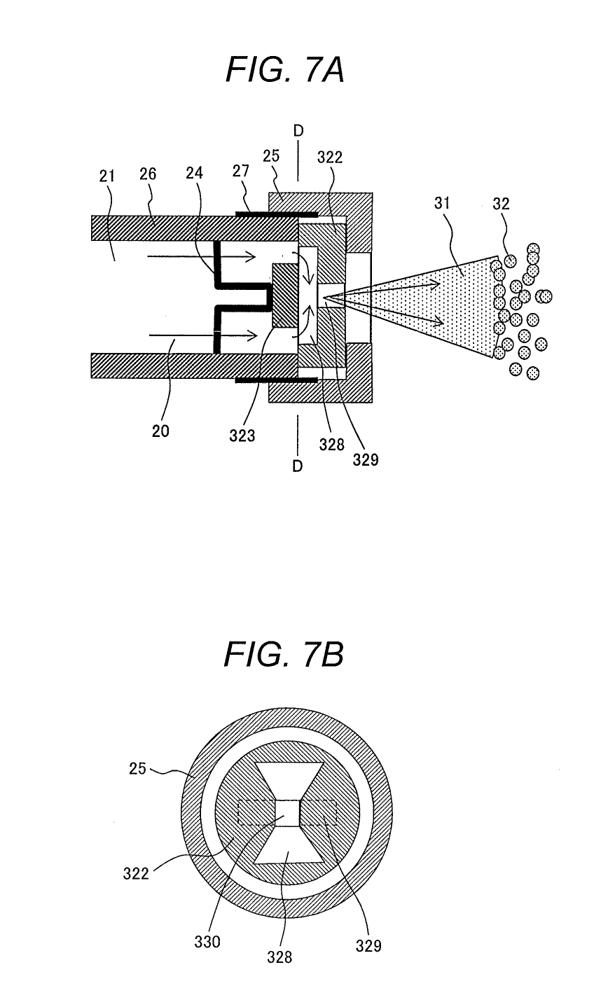

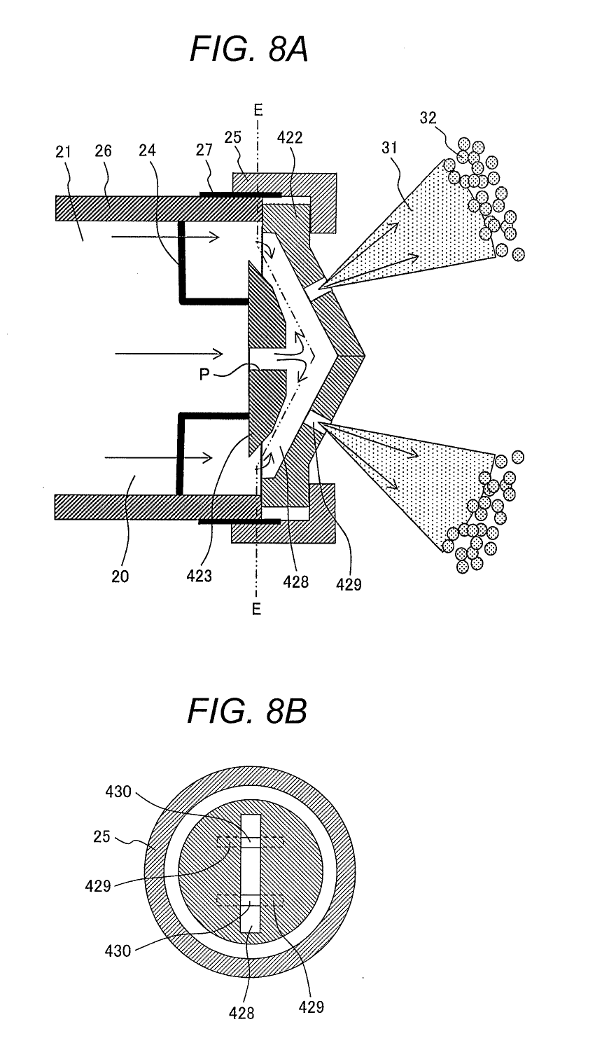

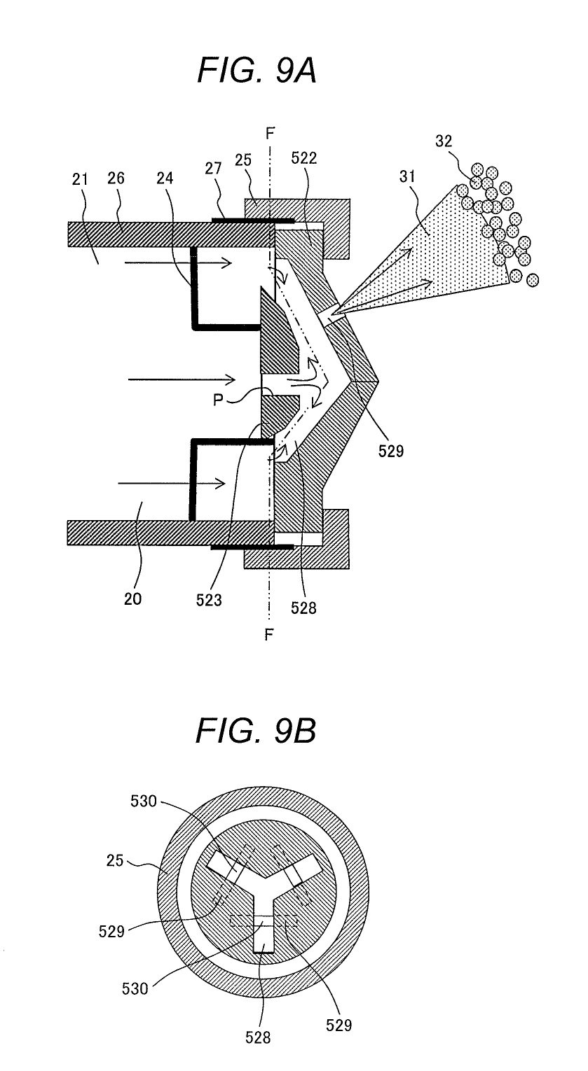

### BRIEF DESCRIPTION OF DRAWINGS

[FIG. 1] A schematic diagram showing an example of a first structure of a combustion device of the present invention.

[FIG. 2A] A cross-sectional diagram showing a spray nozzle according to an embodiment 1 of the present invention.

[FIG. 2B] An AA cross-sectional diagram of FIG. 2A.

[FIG. 3A] A cross-sectional diagram showing an application of the spray nozzle according to the embodiment 1 of the present invention.

[FIG. 3B] A BB cross-sectional diagram of FIG. 3A.

[FIG. 4] A schematic diagram showing an example of a second structure of the combustion device of the present invention.

[FIG. 5A] A cross-sectional diagram showing the spray nozzle according to an embodiment 2 of the present invention.

[FIG. 5B] A CC cross-sectional diagram of FIG. 5A.

[FIG. 6] A schematic diagram showing an example of a third structure of the combustion device of the present invention.

[FIG. 7A] A cross-sectional diagram showing the spray nozzle according to an embodiment 3 of the present invention.

[FIG. 7B] A DD cross-sectional diagram of FIG. 7A.

[FIG. 8A] A cross-sectional diagram showing the spray nozzle according to an embodiment 4 of the present invention.

[FIG. 8B] An EE cross-sectional diagram of FIG. 8A.

[FIG. 9A] A cross-sectional diagram showing an application of the spray nozzle according to the embodiment 4 of the present invention.

[FIG. 9B] An FF cross-sectional diagram of FIG. 9A.

### DESCRIPTION OF EMBODIMENTS

Hereinbelow, working examples of the present invention will be described in the respective embodiments.

### Embodiment 1

FIG. 1 shows an example of a first structure of a combustion device of the present invention. In FIG. 1, plural burners 2 to supply fuel and combustion air are installed on a furnace wall of a furnace 1 forming a boiler. The burner 2 is connected to a combustion air supply system 3 and a fuel supply system 4. In the embodiment 1, the combustion air supply system is branched to a pipe 5 connected to the burner and a pipe 6 connected to an air supply port 7 on its downstream side. The respective pipes are connected to flow amount control valve (not shown). Further, the fuel supply system 4, used when liquid fuel is used as fuel, is connected to a liquid fuel supply system (not shown), and a spray nozzle 8 is set at a downstream end.

In the embodiment 1, the combustion air is branched to the pipes 5 and 6, and respectively issued from the burner 2 and the air supply port 7 into the furnace 1. By supplying air less than a necessary logical air amount for complete combustion of the fuel from the burner 2, a reducing region of air-short combustion is formed in the vicinity of the burner in the furnace 1, and combustion gas 9 flows upward in this reducing region. In this reducing region, a part of nitrogen content included in the fuel is generated as a reducing agent, and reaction to reduce NOx caused by combustion with the burner to nitrogen occurs. Accordingly, the NOx concentration at the exit of the furnace 1 is reduced in comparison with a case where all the combustion air is supplied from the burner 2. Note that the unburnt combustible content is reduced by supplying the remaining combustion air from the air supply port 7 and completely combusting the fuel. Combustion gas 10 mixed with the combustion air from the air supply port 7 passes through a flue 12 via a heat exchanger 11 above the furnace 1, and is discharged from a funnel 13 in the atmosphere.

In the spray nozzle of the embodiment 1 shown in FIGS. 2A and 2B, the upstream side is connected to a liquid fuel supply system (not shown), and connected to a downstream end of a fuel fluid duct 21 in which spray fluid 20 flows. The spray nozzle has a nozzle plate 22, a guide member 23, a guide member holding member 24, and a cap 25 to hold the nozzle plate. The holding member 24 and a partition wall 26 of the fuel fluid duct 21 are fixed, and the cap 25 is fixed to the partition wall 26 of the fuel fluid duct 21 with a screw 27. The nozzle plate 22 and the guide member 23 are held and fixed with the partition wall 26, the holding member 24 and the cap 25. In the case of the embodiment 1, it is possible to remove and inspect the nozzle plate 22 and the guide member 23 by loosening the screw 27 of the cap 25. The embodiment 1 has a structure in consideration of decomposition, however, it is possible to fix the nozzle plate and the guide member directly to the partition wall 26 of the fuel fluid duct 21 by welding or the like. In this case, there is no influence on spray performance, but there is difficulty in removal and inspection.

In the nozzle plate 22, upper and lower rectangular channels 28 and 29 are provided from both surfaces, the two channels intersect in a cross shape, and the communicating intersecting part forms a fuel spray hole 30. In the embodiment 1, it has a guide member 23, and this is in contact with the upstream-side channel 28 in the nozzle plate 22, and is provided in a position overlapped with the fuel spray hole 30 with respect to the spray direction of the spray nozzle.

By providing the guide member 23, the spray fluid (liquid fuel) is branched with the above-described guide member 23 from the fuel fluid duct 21 connected to the spray nozzle, passes through the above-described upstream-side channel 28, flows to the fuel spray hole 30 and is issued. At this time, the flow from the fuel fluid duct 21 linearly toward the fuel spray hole 30 is disturbed with the guide member 23. Accordingly, the spray fluid forms opposed two flows toward the fuel spray hole 30 in the upstream-side channel 28, and the flows collide at an obtuse angle of approximately 90° or greater between flow directions, and are sprayed from the fuel spray hole 30. The collision of the two flows form a thin fan-shaped liquid film 31. The liquid film is divided by a shearing force from peripheral gas, and is microminiaturized into spray particles 32. Further, as the spray fluids collide at an obtuse angle, the kinetic momentum in the axial direction of the liquid film 31 and the spray particles 32 is lowered, and the flow velocity of the spray particles 32 is reduced.

In the combustion device using the spray nozzle of the embodiment 1 of the present invention, as the spray particle diameter is small, the combustion reaction is quickened, the combustion efficiency is improved, and the occurrence of ash dust and carbon monoxide is prevented. Further, as the flow velocity of the spray particles is low and the spray particles easily stay in the vicinity of the spray nozzle 8, ignition is quickened and the flame stability is improved. Accordingly, when the combustion air is branched and sprayed from the burner 2 and the air supply port 7 in the furnace 1 as in the case of the combustion device shown in FIG. 1, a reducing region of air-short combustion is quickly formed in the vicinity of the burner of the furnace 1 and expanded in the furnace 1. As the reducing region is expanded, the stay time of the combustion gas 9 staying in the reducing region is increased. Accordingly, the reaction to reduce the NOx caused by combustion to nitrogen is promoted, and the amount of NOx exhausted from the exit of the furnace 1 is reduced.

Further, as in the application shown in FIGS. 3A and 3B, it is possible to form plural channels 129 in a nozzle plate 122 and form plural fuel spray holes 130 with a channel 128. The central part of a guide member 123 is provided with a hole P for entrance of fluid. In this case, by forming plural intersecting parts in comparison with the use of single intersecting part, the length of outer edge of the intersecting part is longer even in the same cross-sectional area, the contact area between the liquid film sprayed from the intersecting part and the peripheral gas is increased, and more easily divided by the shearing force. Accordingly, in comparison with the use of single intersecting part, the atomization performance in the same spray fluid amount is higher.

Note that in the combustion device shown in FIG. 1, the combustion air is branched and sprayed from the burner 2 and the air supply port 7 in the furnace 1. However, even when all amount of the combustion air is supplied from the burner 2, by using the spray nozzle of the embodiment 1 of the present invention, the combustion reaction is quickened and the combustion efficiency is improved, and the occurrence of ash dust and carbon monoxide is prevented. Further, as the flow velocity of the spray particles is low and the spray particles easily stay in the vicinity of the spray nozzle 8, the ignition is quickened, and the flame stability is improved. As the flame stability is improved, the reaction to reduce NOx caused in the flame to nitrogen is promoted, and the amount of NOx exhausted from the exit of the furnace 1 is reduced.

Further, in the embodiment 1, as the combustion device, liquid fuel is used, however, it is applicable to a case where solid fuel such as fine powdered coal is used as main fuel and liquid fuel is used as secondary fuel. In this case, when the liquid fuel is sprayed from the spray nozzle 8 into the furnace 1, the above-described advantages are obtained.

### Embodiment 2

FIG. 4 shows an example of a second structure of the combustion device of the present invention. In the combustion device shown in FIG. 4, solid fuel such as fine powdered coal orbiomass is used as main fuel and liquid fuel is used as secondary fuel upon activation and low-load operation.

For this purpose, the burner 2 is connected to a fuel pipe 41 connected to a solid fuel supply system (not shown) and a fuel pipe 42 connected to liquid fuel supply system (not shown). The burner 2 has a fuel nozzle 43 in its center, and an air nozzle 44, connected to the combustion air supply system 3, to supply combustion air into the furnace, on its outer periphery. Note that in the embodiment shown in FIG. 4, air is shown as an example of an oxidizing agent for the solid fuel and liquid fuel, however, an oxidizing agent such as oxygen may be used.

The liquid fuel spray nozzle is included in the burner 2. The combustion device shown in FIG. 4 has the spray nozzle 8 in the vicinity of the exit of the air nozzle 44, and the spray nozzle 8 is connected to the fuel pipe 42. The other members are the same as those of the combustion device shown in FIG. 1.

The spray nozzle of the embodiment 2 shown in FIGS. 5A and 5B basically has approximately the same structure as that of the spray nozzle of the embodiment 1. A nozzle plate 222 has a convex shape formed with two flat surfaces to which a guide member in a corresponding shape is closely attached. In the nozzle plate 222, the downstream-side surface is provided with plural channels 229, and the upstream-side surface is provided with channels 228 orthogonal to those channels, thus plural fuel spray holes 230 are provided. The difference from the embodiment 1 is that the combinations of the channels 228 and 229 are formed in the flat surface inclined in a direction symmetric with respect to the flow direction of the spray fluid flowing through the fuel pipe 42. Accordingly, the spray fluid (liquid fuel) sprayed from the fuel spray holes 230 is sprayed at mutually opposite angles, and spray particles spread in a wide range (angle). Accordingly, the mutual collision among the spray particles is prevented, and the generation of large particles can be suppressed.

As an application of the spray nozzle of the embodiment 2, in addition to a case where the downstream-side surface of the nozzle plate is formed with a flat surface having an angle in the opposite direction with respect to the axial direction of the spray nozzle, it may be arranged such that the downstream-side surface of the nozzle plate has a conical shape and the surface is provided with plural channels.

### Embodiment 3

FIG. 6 shows an example of a third structure of the combustion device of the present invention. In the combustion device shown in FIG. 6, solid fuel such as fine powdered coal or biomass is used as main fuel, and especially, the device has two systems i.e. a system for use as liquid fuel for activation and a system for use upon low load operation. Accordingly, the burner 2 is connected to the fuel pipe 41 connected to a solid fuel supply system (not shown) and the fuel pipes 42 and 52 connected to the liquid fuel supply system (not shown). The burner 2 has a fuel nozzle 43 in its center, and the air nozzle 44, connected to the combustion air supply system 3, to supply combustion air into the furnace, on its outer periphery.

The spray nozzle for liquid spray fuel is included in the burner 2. In FIG. 6, the combustion device has the spray nozzle 8 for activation in the vicinity of the exit of the air nozzle 44, and the spray nozzle 8 is connected to the fuel pipe 42. Further, it has a spray nozzle 52 for secondary combustion. Upon activation of the burner 2, liquid fuel is sprayed from the spray nozzle 8 and ignition is caused. Then, the liquid fuel is sprayed from the secondary combustion spray nozzle 52, and operation is made within a low load range. When the temperature in the furnace has sufficiently risen, the solid fuel supply system is activated, then combustion is changed to solid fuel combustion, and the liquid fuel is stopped. In this manner, it is possible to maintain stable combustion in a wide load range by changing fuel in accordance with running condition. The other members are the same as those of the combustion device shown in FIG. 4.

The spray nozzle of the embodiment 3 of the present invention shown in FIGS. 7A and 7B basically has approximately the same structure as that of the spray nozzle of the embodiment 1 of the present invention. The upper and lower surfaces of a nozzle plate 322 are provided with channels 328 and 329, and they become fuel spray holes by communication with the fuel spray holes 330. In the embodiment 3, a guide member 323 is provided, and this is provided, in contact with the upstream-side channel 328 of the nozzle plate 322, in a position overlapped with the fuel spray hole 330 with respect to the spray direction of the spray nozzle. The difference from the embodiment 1 is that the fluid-duct cross-sectional area of the upstream-side channel 328 of the channels 328 and 329 is changed in the flow direction. In FIG. 7B, the fluid-duct cross-sectional area of the fluid entering the channel 328 is gradually decreased.

Accordingly, as the spray fluid flowing on the upstream side approaches the exit of the fuel spray hole, the flow velocity is increased. At this time, turbulence occurs in the fluid duct by the change of the flow velocity, to prevent sedimentation of solid materials in the fluid duct.

In a case were the solid materials are stacked in the fluid duct, when the solid materials grow by chemical reaction or the like, there is a probability of occlusion of the fluid duct. When a part of the fluid duct is occluded, the atomization performance of the spray nozzle is deteriorated and large diameter particles occur. The large diameter particles delay the combustion reaction. Accordingly, in the combustion device using the spray nozzle, there are probabilities of reduction of combustion efficiency and occurrence of ash dust and carbon monoxide. It is possible to operate the combustion device in a stable manner for a long time with the structure to prevent sedimentation of solid materials in a fluid duct as in the case of the present embodiment.

### Embodiment 4

As in the case of the spray nozzle shown in FIGS. 8A and 8B, even when plural fuel spray holes 430 are provided, the above advantage can be obtained. In the embodiment 4, as shown in FIG. 8A, the shape of the guide member 423 is changed such that the fluid duct area is changed in a cross section parallel to the flow direction. Especially, as shown in FIGS. 8A and 8B, when plural fuel spray holes 430 are provided by intersecting the channels 428 and 429 provided in the nozzle plate 422, it is preferable to connect the respective upstream-side channels 428 so as to flow the spray fluid, flowing from a fluid flow-in hole P at a central part, from any of the plural fuel spray holes 30. At this time, when slight pressure change occurs in the fluid duct by flow of solid material or the like, as the channel 428 is directly connected, the flow amount distribution of the spray fluid flowing inside is changed. Accordingly, turbulence occurs in the flow, to suppress the sedimentation of solid materials.

FIGS. 9A and 9B show an application where the number of the fuel spray holes in FIGS. 8A and 8B is three. Three channels 529 are formed on the downstream side of a nozzle plate 522, and Y-shaped channels 528 orthogonal to them are formed on the upstream side, to form three fuel spray holes 530.

### REFERENCE SIGNS LIST

1: furnace
2: burner
3: combustion air supply system
4: fuel supply system
8, 52: spray nozzle
11: heat exchanger
20: spray fluid
21: fuel fluid duct
22, 122, 222, 322, 422, 522: nozzle plate
23, 123, 223, 323, 423, 523: guide member
28, 128, 228, 328, 428, 528: channel (upstream side)
29, 129, 229, 329, 429, 529: channel (downstream side)
30, 130, 230, 330, 430, 530: fuel spray hole
31: liquid film
32: spray particle

1. A spray nozzle which pressurizes liquid fuel as spray fluid and supplies it from upstream to downstream of a fluid to spray it from an end, wherein at least one channel is formed in respective both surfaces of a nozzle plate provided at the end of the spray nozzle, and an intersecting part of the two channels is used as a fuel spray hole,
wherein, a guide member is in contact with the upstream-side channel provided in the both surfaces of the nozzle plate, the guide member is provided for spray fluid flowing through a fluid duct on the upstream side of the intersecting part, and the fluid is guided toward the fuel spray hole and collided from opposite directions.

2. The spray nozzle according to claim 1, wherein the angle of the flow direction of the fluids guided toward the fuel spray hole and collided from the opposite directions with the guide member is an obtuse angle.

3. The spray nozzle according to claim 1, wherein, the nozzle plate has flat surfaces at different angles with respect to the spray nozzle axial direction, and plural fuel spray holes are formed by providing a plurality of at least one of the channels formed in the both surfaces of the nozzle plate and using combinations of the channels.

4. The spray nozzle according to claim 3, wherein the axial direction of the plural fuel spray holes is inclined in a direction symmetric with respect to the flow direction of the spray fluid flowing through the fluid duct at the end of which the spray nozzle is provided, and injection is performed.

5. The spray nozzle according to claim 1, wherein the fluid-duct cross-sectional area of the upstream-side channel of the channels is changed in the flow direction of the spray fluid flowing through the upstream-side channel.

6. The spray nozzle according to claim 5, wherein the fluid-duct cross-sectional area of the upstream-side channel is decreased toward the fuel spray hole.

7. The spray nozzle in claim 5, wherein the upstream-side channels are mutually connected.

8. A combustion device using liquid fuel as at least a part of fuel, and having a spray nozzle which pressurizes the liquid fuel and sprays it, comprising: a combustion furnace to combust fossil fuel; a fuel supply system to supply fuel and carrier gas to carry the fuel to the combustion furnace; a combustion gas supply system to supply combustion gas to the combustion furnace; a burner provided on a furnace wall of the combustion furnace and connected to the fuel supply system and the combustion gas supply system, to combust the fossil fuel; and a heat exchanger for heat exchange from combustion exhaust gas caused in the combustion furnace to the outside,
wherein the spray nozzle according to claim 1 is used as the spray nozzle.

9. The spray nozzle according to claim 2, wherein, the nozzle plate has flat surfaces at different angles with respect to the spray nozzle axial direction, and plural fuel spray holes are formed by providing a plurality of at least one of the channels formed in the both surfaces of the nozzle plate and using combinations of the channels.

10. The spray nozzle according to claim 2, wherein the fluid-duct cross-sectional area of the upstream-side channel of the channels is changed in the flow direction of the spray fluid flowing through the upstream-side channel.

11. The spray nozzle according to claim 3, wherein the fluid-duct cross-sectional area of the upstream-side channel of the channels is changed in the flow direction of the spray fluid flowing through the upstream-side channel.

12. The spray nozzle according to claim 4, wherein the fluid-duct cross-sectional area of the upstream-side channel of the channels is changed in the flow direction of the spray fluid flowing through the upstream-side channel.

13. The spray nozzle in claim 6, wherein the upstream-side channels are mutually connected.

14. A combustion device using liquid fuel as at least a part of fuel, and having a spray nozzle which pressurizes the liquid fuel and sprays it, comprising: a combustion furnace to combust fossil fuel; a fuel supply system to supply fuel and carrier gas to carry the fuel to the combustion furnace; a combustion gas supply system to supply combustion gas to the combustion furnace; a burner provided on a furnace wall of the combustion furnace and connected to the fuel supply system and the combustion gas supply system, to combust the fossil fuel; and a heat exchanger for heat exchange from combustion exhaust gas caused in the combustion furnace to the outside, wherein the spray nozzle according to claim 2 is used as the spray nozzle.

15. A combustion device using liquid fuel as at least a part of fuel, and having a spray nozzle which pressurizes the liquid fuel and sprays it, comprising: a combustion furnace to combust fossil fuel; a fuel supply system to supply fuel and carrier gas to carry the fuel to the combustion furnace; a combustion gas supply system to supply combustion gas to the combustion furnace; a burner provided on a furnace wall of the combustion furnace and connected to the fuel supply system and the combustion gas supply system, to combust the fossil fuel; and a heat exchanger for heat exchange from combustion exhaust gas caused in the combustion furnace to the outside,
wherein the spray nozzle according to claim 3 is used as the spray nozzle.

16. A combustion device using liquid fuel as at least a part of fuel, and having a spray nozzle which pressurizes the liquid fuel and sprays it, comprising: a combustion furnace to combust fossil fuel; a fuel supply system to supply fuel and carrier gas to carry the fuel to the combustion furnace; a combustion gas supply system to supply combustion gas to the combustion furnace; a burner provided on a furnace wall of the combustion furnace and connected to the fuel supply system and the combustion gas supply system, to combust the fossil fuel; and a heat exchanger for heat exchange from combustion exhaust gas caused in the combustion furnace to the outside,
wherein the spray nozzle according to claim 4 is used as the spray nozzle.

17. A combustion device using liquid fuel as at least a part of fuel, and having a spray nozzle which pressurizes the liquid fuel and sprays it, comprising: a combustion furnace to combust fossil fuel; a fuel supply system to supply fuel and carrier gas to carry the fuel to the combustion furnace; a combustion gas supply system to supply combustion gas to the combustion furnace; a burner provided on a furnace wall of the combustion furnace and connected to the fuel supply system and the combustion gas supply system, to combust the fossil fuel; and a heat exchanger for heat exchange from combustion exhaust gas caused in the combustion furnace to the outside,
wherein the spray nozzle according to claim 5 is used as the spray nozzle.

18. A combustion device using liquid fuel as at least a part of fuel, and having a spray nozzle which pressurizes the liquid fuel and sprays it, comprising: a combustion furnace to combust fossil fuel; a fuel supply system to supply fuel and carrier gas to carry the fuel to the combustion furnace; a combustion gas supply system to supply combustion gas to the combustion furnace; a burner provided on a furnace wall of the combustion furnace and connected to the fuel supply system and the combustion gas supply system, to combust the fossil fuel; and a heat exchanger for heat exchange from combustion exhaust gas caused in the combustion furnace to the outside,
wherein the spray nozzle according to claim 6 is used as the spray nozzle.

19. A combustion device using liquid fuel as at least a part of fuel, and having a spray nozzle which pressurizes the liquid fuel and sprays it, comprising: a combustion furnace to combust fossil fuel; a fuel supply system to supply fuel and carrier gas to carry the fuel to the combustion furnace; a combustion gas supply system to supply combustion gas to the combustion furnace; a burner provided on a furnace wall of the combustion furnace and connected to the fuel supply system and the combustion gas supply system, to combust the fossil fuel; and a heat exchanger for heat exchange from combustion exhaust gas caused in the combustion furnace to the outside,
wherein the spray nozzle according to claim 7 is used as the spray nozzle.
